(19) United States
(12) Patent Application Publication
(10) Pub. No.: US 2013/0309437 A1
(43) Pub. Date: Nov. 21, 2013

(54) METHOD FOR PRODUCING AN OPTICAL ELEMENT

(71) Applicant: OSRAM GmbH, Muenchen (DE)

(72) Inventor: Gertrud Kraeuter, Regensburg (DE)

(73) Assignee: OSRAM GmbH, Muenchen (DE)

(21) Appl. No.: 13/894,461

(22) Filed: May 15, 2013

(30) Foreign Application Priority Data
May 16, 2012 (DE) 102012208287.5

(51) Int. Cl. B05D 5/06; C09K 11/02

(52) U.S. Cl. CPC B05D 5/06; C09K 11/02
USPC 428/68; 427/162; 257/98; 252/301.4 F

(57) ABSTRACT

A method for producing a luminescent material element which is configured for conversion of pump light is provided. The method may include: providing a polysilazane solution; bringing the polysilazane solution in contact with a luminescent material; and partially curing the polysilazane solution.

### CROSS-REFERENCE TO RELATED APPLICATION

This application claims priority to German Patent Application Serial No. 10 2012 208 287.5, which was filed May 16, 2012, and is incorporated herein by reference in its entirety.

### TECHNICAL FIELD

Various embodiments relate generally to a method for producing a luminescent material element which is configured for conversion of pump light.

### BACKGROUND

The use of luminescent materials for converting higher-energy pump light into useful light with a longer wavelength is already known from fluorescent lamps, in which for example UV light generated in a mercury gas is converted into visible light by the luminescent material.

In very recent developments, which relate for example to the combination of a high power density light source with a luminescent material element arranged at a distance therefrom, originally higher-energy pump light is also converted according to this principle using luminescent material, in which case the useful light may also be a mixture of pump light and conversion light. In order to produce a luminescent material element, the luminescent material is for example deposited electrophoretically onto a substrate, on which a corresponding luminescent material layer is then arranged.

### SUMMARY

A method for producing a luminescent material element which is configured for conversion of pump light is provided. The method may include: providing a polysilazane solution; bringing the polysilazane solution in contact with a luminescent material; and partially curing the polysilazane solution.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an idealized representation of the molecular structure of perhydropolysilazane;

FIGS. 2A and 2B show coating of a semiconductor LED component with SiOₓ including luminescent material particles embedded therein; and

FIG. 2C shows a semiconductor LED component which is coated with a luminescent material layer and is encapsulated by an SiOₓ layer.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments provide an advantageous method for producing a luminescent material element configured for the conversion of pump light, a corresponding luminescent material element and an advantageous use.

According to various embodiments, a method is provided, which may include:
providing a polysilazane solution;
bringing the polysilazane solution in contact with a luminescent material;
partially curing the polysilazane solution;

and a correspondingly produced luminescent material element, that is to say a shaped body including luminescent material embedded or encapsulated therein; and the use of a corresponding luminescent material element for a projection device, an endoscope, room lighting purposes, industrial and/or medical applications.

The basic idea of various embodiments may consist in protecting the luminescent material, for example against environmental influences, with a partially cured polysilazane solution. This is because, with internal heating during the light conversion, for example due to the Stokes shift, e.g. the chemical interaction with the material surrounding the luminescent material, i.e. usually air or water vapor, can also be crucial for the degradation of a luminescent material.

This basic concept may be used in two ways, namely on the one hand by the luminescent material being embedded in a partially cured polysilazane solution in a method according to various embodiments, specifically by luminescent material being added to the polysilazane solution, i.e. admixed with the solution. On the other hand, a polysilazane solution may also be applied onto a luminescent material arrangement, e.g. onto a luminescent material layer, so that the latter is “encapsulated” (in this case, there is e.g. no luminescent material in the polysilazane solution itself).

In the first variant, the luminescent material is embedded, i.e. distributed in a matrix. In this case, the matrix may thus be constituted by the polysilazane itself or be formed therefrom, i.e. the luminescent material may be incorporated between polymer chains or distributed in SiOₓ formed from polysilazane. The polysilazane may thus be not only partially cured but also fully cured; in the case of perhydropolysilazane, an SiOₓ matrix is formed, which will be explained in more detail in the scope of the various configurations.

Of course, these possibilities (polysilazane coating or SiOₓ coating) also apply in the second variant, i.e. the encapsulation according to various embodiments; in the scope of various embodiments, distinction will in general not always be made between the description of the method, the description of the luminescent material element thereby produced and the description of the use; rather, the features are also meant to be disclosed for the other respective categories.

The polysilazane solution is at least partially cured, i.e. its viscosity increases, specifically relative to its viscosity at the time when it is brought in contact with the luminescent material (if, for example, luminescent material is admixed over a prolonged period of time when adding luminescent material, then at the start of this). “Partially cured” specifically means a state in which the viscosity has increased by at least 10%, 20%, 30% or 40%, increasingly preferably in this order. A solid body, which is not necessarily but e.g. rigid, is e.g. formed, which is referred to as “curing”.

A polysilazane is a polymer, i.e. it is constructed from one (or more) monomers as basic units. The basic skeleton is in this case formed by silicon and nitrogen, at least two nitrogen atoms being bonded to a silicon atom and at least two silicon atoms being bonded to a nitrogen atom; in an organopolysilazane, there is furthermore at least one organic radical on the silicon, while in the case of the perhydropolysilazane, which is explained in more detail in the scope of various embodiments, only hydrogen atoms are present as substituents.

In general, the polysilazane may thus also be an organopolysilazane. During the partial curing, the crosslinking of the polysilazane molecules then increases, for example as far as a gel-like consistency; curing to form a solid body is also possible, and a duromer may for example be used.

The proportion of polysilazane in the polysilazane solution may for example be at least 5 wt. %, 10 wt. % or 15 wt. %, increasingly e.g. in this order, and, independently of the lower limit, at most 35 wt. %, 30 wt. % or 25 wt. %, increasingly e.g. in this order; e.g., this applies for the polysilazane solution when adding luminescent material to it/applying it onto a luminescent material arrangement.

In general, monomers or polymers crosslink during the partial curing, and polymer chains or polymer rings are thus extended or formed. Depending on the size of the organic radical of an organopolysilazane, this may also influence the properties of the resulting macromolecules, so that for example large side groups may reduce the interaction with water owing to a “shielding effect”, which may also be advantageous in respect of the embedding/encapsulation of the luminescent material.

“Providing a polysilazane solution” is also intended to include providing silazane monomers; nevertheless, there will usually already be a certain degree of crosslinking.

When luminescent material is added to the polysilazane solution, the former may for example be provided in particle form with an average particle size of from a few tens of nm to several millimeters, values of between 1 and 30 μm being usual, and it may thus for example be dispersed well in the polysilazane solution. If for example particularly uniform embedding of the luminescent material is intended to be achieved, the polysilazane solution may also be homogenized, for example by shaking or stirring, during or after the addition of luminescent material.

Although the encapsulation according to various embodiments, i.e. the application of a polysilazane solution onto a luminescent material arrangement, e.g. a luminescent material layer, may in general also be carried out with a polysilazane solution to which luminescent material is added, a polysilazane solution without luminescent material is, however, e.g. in this case. In general, the polysilazane solution could also be applied onto the luminescent material arrangement by brushing; spraying or dispensing, i.e. dosed application, may however be provided.

Various configurations are specified in the dependent claims and in the description below; as already mentioned, the individual features are meant to be disclosed in respect of all categories.

A perhydropolysilazane may be provided as the polysilazane, i.e. a silazane saturated only with hydrogen without an organic radical. One advantage of the perhydropolysilazane may be that it can be cured to form an SiOₓ network. The network is consequently then preferably free of nitrogen and carbon (of course, an organic luminescent material may be embedded therein).

In various configuration, the perhydropolysilazane solution is thus cured to form a vitreous shaped body, in which the previously admixed luminescent material is then embedded or encapsulated. In various configurations, if this shaped body is a layer, for example on the surface of an optical element, then it has an extent in the layer direction at least 5, 10, 15 or 20 times greater than in the thickness direction, e.g. in this order.

In general, various embodiments thus also relate to a shaped body (consisting of polysilazane and/or SiOₓ) produced by a method according to various embodiments, including luminescent material embedded and/or encapsulated therein, i.e. luminescent material elements. Such a shaped body may be transmissive for pump light and conversion light, and should transmit at least 25%, 50% or 75% of the light, e,g, in this order.

A shaped body having embedded luminescent material is therefore just as possible as a shaped body encapsulating the luminescent material. In this case, “encapsulating” does not necessarily mean that the luminescent material arrangement must be fully enclosed by the shaped body; rather, at least one side of the luminescent material arrangement is at least partially covered with the shaped body. The luminescent material may, for example, also adjoin an optical element on a side opposite the shaped body.

Specifically, a luminescent material element may in general be provided, e.g. in layer form, on an optical element, for instance a mirror or a lens. The luminescent material element and optical element may thus, for example, be connected to one another by a bonding connection, for example an adhesive interlayer; for example, the luminescent material element bears on the optical element with a form fit, and e.g. directly, i.e. without an adhesion promoting interlayer. “Form fit” thus means replicating a (possibly even smooth, but usually curved or contoured) surface profile of the optical element.

In general, an “optical element” may be a component of an optical system, for example of a projection device, and specifically a solid body for guiding, e.g. refracting/focusing and/or reflecting and/or generating light; besides a mirror, an imaging lens or a non-imaging “light guide, for example, this may also refer to an optoelectronic component, e.g. a semiconductor light emitting diode (LED) component.

A “semiconductor LED component” is a semiconductor-based light-emitting diode, which includes both organic light-emitting diodes (so-called OLEDs) and e.g. inorganic light-emitting diodes, based for example on gallium nitride.

The polysilazane solution may thus for example be provided on an output face, which is configured for pump light emission, so that the luminescent material embedded therein/encapsulated thereby then converts at least a part of the pump light. When propagation of light is referred to in this disclosure, this of course does not imply that corresponding propagation of light must actually take place in order to fulfill the subject-matter; it is sufficient for an arrangement to be configured for corresponding propagation or conversion of light.

The vitreous shaped body having luminescent material embedded therein may be advantageous not only in respect of protecting the luminescent material against environmental influences, but also in relation to the thermal constraints. Specifically, the shaped body may have a certain heat capacity/thermal conductivity and thus to some extent cool the luminescent material heated during the light conversion; a reduced operating temperature can, for example, have a positive effect on the lifetime of a luminescent material. The thermal binding of an encapsulated luminescent material can also be improved in this way.

Possible luminescent materials which illustrate various embodiments are, for example, garnet luminescent materials of the form AₓB_{y}C_{z}Al₅O₁₂ (with A, B, C selected from Y, Al, Lu, Ga etc.), for example Ce-doped YAG, an orthosilicate luminescent material or a pure nitride luminescent material; however, the term “luminescent material” also includes a mixture of a plurality of such luminescent material types, i.e. pure luminescent materials.

The production of a vitreous shaped body comprising embedded luminescent material may be carried out with perhydropolysilazane dissolved in di-n-butyl ether; the same applies for the encapsulation, i.e. the application of a polysilazane solution onto a luminescent material arrangement.

The production of a shaped body by applying the polysilazane solution onto a luminescent material arrangement is also meant to be disclosed, independently of the features of the main claim, i.e. independently of the “bringing in contact”. Thus, the polysilazane solution need not then necessarily be applied directly onto the luminescent material, and an interlayer may for example also be provided; the polysilazane solution could thus, for example, be applied onto a luminescent material arrangement which is provided on an optical element and has already previously been provided with a coating of another material, for example SiN passivation.

The polysilazane solution is preferably partially cured and/or cured, at an ambient temperature of at least 30° C., 40° C., 50° C., 60° C., 70° C. or 80° C., increasingly preferably in this order; preferred upper limits, independent of the lower limit just mentioned, are at most 220° C., 200° C., 180° C. or 160° C., increasingly preferably in this order.

With respect to the partial curing and/or curing, an environment having low air humidity may furthermore be advantageous, for which reason dry box conditions are preferred, i.e. a humidity of less than 20%, 10%, 5% or 2%, increasingly preferably in this order. Furthermore, the reaction may for example also be accelerated by a catalyst, for instance methylamine

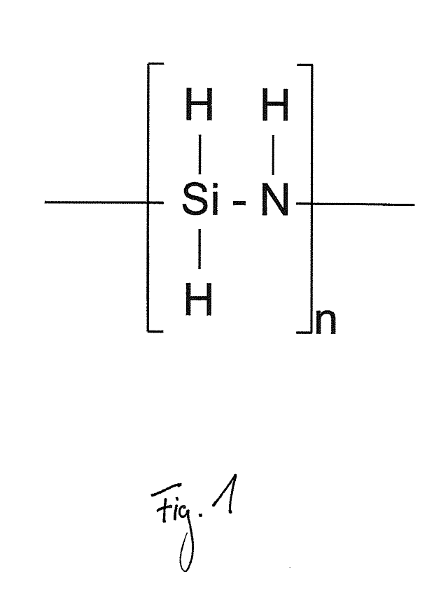

FIG. 1 shows a perhydropolysilazane monomer in a schematic representation. These basic units in polysilazane are crosslinked to form long chain or ring structures, at least two nitrogen atoms being bonded to a silicon atom, and vice versa. In the perhydropolysilazane shown in FIG. 1, the free valencies are saturated with hydrogen; in an organopolysilazane, an organic radical would be bonded instead of at least one hydrogen atom.

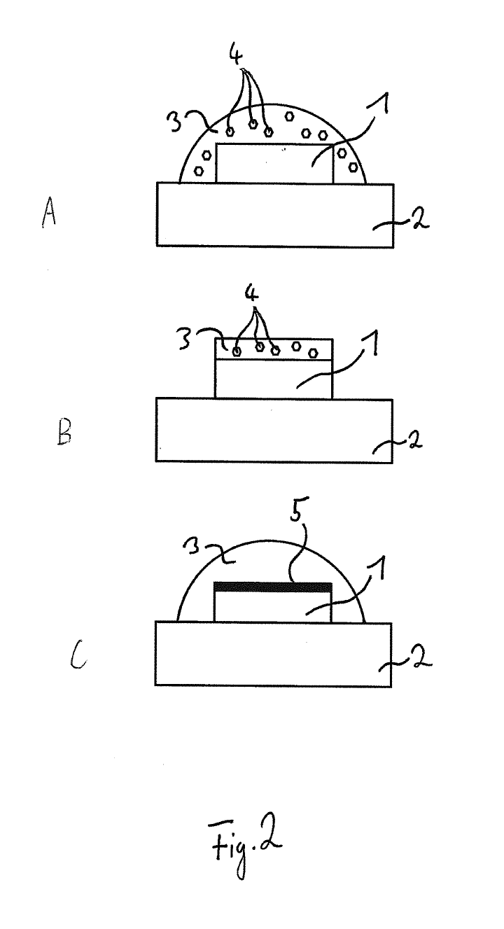

FIG. 2A to FIG. 2C respectively show a semiconductor LED component 1, here an inorganic light-emitting diode based on gallium nitride, which is mounted on a heat sink 2.

In FIG. 2A, the semiconductor LED component is enclosed by a shaped SiOₓ body 3 including luminescent material particles 4 embedded therein. For production, the semiconductor LED component is first mounted on the heat sink 2 in a known way, for example by adhesive bonding or soldering.

After electrical contacting of the semiconductor LED component 1, a perhydropolysilazane solution comprising dispersed luminescent material particles 4, in the present case cerium-doped yttrium aluminum garnet, is dispensed as drops onto the semiconductor LED component 1 and the heat sink 2.

The perhydropolysilazane used here is dissolved in di-n-butyl ether, specifically as a 20 wt. % strength solution with a density of 0.82 g/cm² and a viscosity of less than 5 mPas at 20° C. Such a perhydropolysilazane solution is available under the designation NN 120-20 from Clariant.

After dispensing of the perhydropolysilazane solution comprising luminescent material particles, it is cured at a temperature of 110° C. with the addition of a catalyst. In this case, nitrogen is applied in the form of ammonia and the vitreous shaped SiOₓ body 3 is formed. The shape of the latter may be more similar to the semiconductor LED component than is illustrated in the schematic representation according to FIG. 2A. For example, it may also form a layer having a thickness of only a few micrometers, which encloses the semiconductor LED component 1.

FIG. 2B shows such an SiOₓ layer 3, which in this case is applied only onto the surface of the semiconductor LED component 1, but does not cover its sides; this may, for example, be advantageous in respect of material consumption. Such a layer 3 can cover the semiconductor LED component 1 sufficiently for the light conversion, because the pump light emerges from an output face arranged on the surface.

In both FIG. 2A and FIG. 2B, the shaped SiOₓ body 3, i.e. the layer, bears on the semiconductor LED component 1 with a form fit; the shaped body may, for example, also bear on a surface contour (not shown in the schematic representation).

FIG. 2C shows a semiconductor LED component 1 including a luminescent material layer 5 provided on the surface. The luminescent material layer 5 may, for example, be deposited electrophoretically.

Subsequently, a perhydropolysilazane solution as described above is applied and is cured in a manner likewise described above, so that the luminescent material layer 5 is encapsulated by a shaped SiOₓ body and is protected, for example, against environmental influences.

In the case of all the exemplary embodiments according to FIG. 2A to FIG. 2C, the shaped SiOₓ body also has advantages in respect of the thermal bonding of the luminescent material 4, 5, because the SiOₓ material can lead to a certain degree of cooling.

In various embodiments, a luminescent material element as described above or an optical element as described above may be used for at least one of: a projection device, an endoscope, room lighting purposes, industrial and medical applications.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for producing a luminescent material element which is configured for conversion of pump light, the method comprising:
providing a polysilazane solution;
bringing the polysilazane solution in contact with a luminescent material; and
partially curing the polysilazane solution.

2. The method as claimed in claim 1,
wherein the luminescent material is added to the polysilazane solution.

3. The method as claimed in claim 1,
wherein the polysilazane solution is applied onto a luminescent material arrangement.

4. The method as claimed in claim 3,
wherein the polysilazane solution is applied onto a luminescent material layer.

5. The method as claimed in claim 1,
wherein the polysilazane solution is applied by one of: spraying and dispensing.

6. The method as claimed in claim 1,
wherein perhydropolysilazane is provided as the polysilazane.

7. The method as claimed in claim 6,
wherein the perhydropolysilazane solution is cured to form a vitreous shaped body comprising at least one of: embedded and encapsulated luminescent material.

8. The method as claimed in claim 7,
wherein the perhydropolysilazane solution is cured to form a vitreous shaped layer.

9. The method as claimed in claim 6,
wherein a solution of perhydropolysilazane in di-n-butyl ether is provided as the polysilazane solution.

10. The method as claimed in claim 1,
wherein the partial curing is carried out at an ambient temperature of at least 30° Celsius.

11. The method as claimed in claim 1,
wherein the partial curing is carried out under at least one of: dry box conditions and the effect of a catalyst.

12. The method as claimed in claim 2,
wherein after the luminescent material is added to the polysilazane solution, the latter is applied onto an optical element, in particular a semiconductor light emitting diode component.

13. A luminescent material element, which is configured for conversion of pump light and is produced by a method comprising:
providing a polysilazane solution;
bringing the polysilazane solution in contact with a luminescent material; and
partially curing the polysilazane solution.;
in such a way that a luminescent material is at least one of: embedded and encapsulated in a shaped body.

14. The luminescent material element as claimed in claim 13,
wherein the luminescent material is added to the polysilazane solution;
wherein the luminescent material is embedded in the vitreous shaped body.

15. An optical element, comprising:
on which a luminescent material element is provided, the luminescent material element, which is configured for conversion of pump light and is produced by a method comprising:
providing a polysilazane solution;
bringing the polysilazane solution in contact with a luminescent material; and
partially curing the polysilazane solution;
in such a way that a luminescent material is at least one of: embedded and encapsulated in a shaped body.

16. The optical element as claimed in claim 15,
configured as a semiconductor light emitting diode element.
